(19) United States
(12) Patent Application Publication
(10) Pub. No.: US 2018/0314976 A1
(43) Pub. Date: Nov. 1, 2018

(54) RECOMMENDING A GROUP TO A USER OF A SOCIAL NETWORKING SYSTEM BASED ON AN AFFINITY OF THE USER FOR AN INFERRED TOPIC ASSOCIATED WITH THE GROUP

(71) Applicant: Facebook, Inc., Menlo Park, CA (US)

(72) Inventors: Yi Miao, Redmond, WA (US); Ritika Prasad, Seattle, WA (US); Li Ju, Issaquah, WA (US); Eric Carl Ertmann, San Francisco, CA (US); Haebin Kim, San Francisco, CA (US)

(21) Appl. No.: 15/499,751

(22) Filed: Apr. 27, 2017

(51) Int. Cl. G06N 99/00; H04L 12/58; H04L 29/08; G06Q 50/00; G06N 5/04

(52) U.S. Cl. CPC G06N 99/005; H04L 51/32; G06N 5/04; H04L 67/18; G06Q 50/01; H04L 67/306

(57) ABSTRACT

A social networking system allows users of the social networking system to create and join various groups maintained in the social networking system. The social networking system may partition the groups into a geographical grid based on geographic locations associated with the groups, such that each group is associated with a portion of the geographical grid. Each group is associated with one or more topics, which may be inferred by the social networking system based on content posted by members of the group in association with the group and attributes associated with members of the group. Each group is also associated with membership criteria that include attributes for members of the group. Based on the geographical grid, the topics, and/or the membership criteria associated with the groups, the social networking system may select one or more groups to recommend to a user of the social networking system.

### BACKGROUND

This disclosure relates generally to social networking systems, and more specifically to recommending groups to users of a social networking system.

A social networking system allows its users to connect and communicate with other social networking system users. Users create profiles in the social networking system that are tied to their identities and that include information about the users, such as interests and demographic information. The users may be individuals or entities, such as corporations or charities. Because of the popularity of social networking systems and the significant amount of user-specific information maintained in social networking systems, a social networking system provides an ideal forum for allowing users to create and join various groups of users (“groups”) in the social networking system who share common interests (e.g., recreational hobbies, occupational backgrounds, political viewpoints, etc.).

Groups maintained in a social networking system are associated with topics that are common to social networking system users who are members of the same group. For example, topics associated with groups include interests, associations, affiliations, and/or any other characteristics common to a group of users. For example, members of a group may share a common workplace, a favorite celebrity, or a religious view. Groups enable social networking system users to easily connect to and communicate with additional social networking system users belonging to the same group, for example, by posting content to the group, by participating in group discussions, etc.

Conventionally, social networking systems may present recommendations to social networking system users that suggest that the users join various groups in order to encourage user engagement with the social networking systems. Social networking system users are more likely to join a group that is recommended to them if the group is associated with a topic in which they have an interest. Therefore, a social networking system may select one or more groups that are associated with various topics in which a user is likely to have an interest and recommend that the user join the selected group(s). For example, if a user is associated with a user profile that indicates that the user is located in London, England and that the user's interests include photography, the social networking system may identify a photography group that is associated with a geographic location near London, England. If the user is not currently a member of the group, the social networking system may recommend that the user join the group.

Topics associated with groups may be identified based on information provided by social networking system users. For example, a user who requests to create a group may explicitly provide a title or a description for the group at the time the request is submitted. This information may then be used by a social networking system to identify one or more topics as sociated with the group (e.g., based on keywords included in the title or description), which may then be used to determine whether a user is likely to have an interest in the group. However, users may provide ambiguous or incomplete information associated with groups. For example, a user requesting to create a group associated with Ford Mustang automobiles may specify a name of the group to be “Mustang Lovers” and a description of the group to be “For those who appreciate the beauty and power of a Mustang.” However, absent additional information provided by the user or other contextual information that indicates a topic of automobiles associated with the group, the social networking system may incorrectly associate the group with another topic associated with the term “Mustang” (e.g., the topic of horses or military aircraft). Hence, the social networking system may fail to recommend the group to social networking system users who have indicated an interest in automobiles and may instead recommend the group to social networking system users who have not indicated an interest in automobiles. By recommending that users join groups associated with topics in which the users have not indicated an interest, users of a social networking system are likely to decide against joining the groups and may even reduce their interaction with the social networking system.

### SUMMARY

A social networking system allows users of the social networking system to create and join various groups maintained in the social networking system. Groups allow social networking system users to easily connect to and share content with additional users who are members of the same group. For example, members of a group may post content to the group, participate in group chats, upload photos to albums shared by the group, and collaborate on documents shared by the group. Each group is associated with one or more topics of interest (“topics”) shared by users who are members of the same group. For example, members of a group may be family members, teammates in a sports league, coworkers, or users who share a common hobby or a common sentiment (e.g., dissatisfaction with the results of an election). In addition to topics, each group may be associated with additional information that is maintained in the social networking system, such as membership criteria (e.g., attributes) that must be met by members of the group, content items associated with the group, etc. For example, for a group of social networking system users who are fans of a particular stand-up comedian, the social networking system may maintain information associated with the group that describe a minimum age requirement for group members, topics such as stand-up comedy and the comedian's name, and content items posted by members of the group to a page maintained in the social networking system that is associated with an account for the group on the social networking system.

The social networking system may infer topics associated with groups based on information associated with the groups and/or members of the groups. Topics associated with a group may be inferred using a machine-learning algorithm based on metadata (e.g., tags) associated with content posted to the group, attributes associated with members of the group, etc. For example, the social networking system may infer that a group is associated with the topic of graduates of a particular high school who graduated in the year 2000 based on attributes associated with members of the group (e.g., profile information indicating each group member attended the same high school and graduated in the year 2000, content items posted by group members having keywords such as “reunion,” etc.). As an additional example, the social networking system may infer that a group is associated with the topics of guitar playing and alternative rock music based on profile information associated with members of the group describing the members as professional guitar players and guitar teachers and names of alternative rock bands and songs included in content items posted by members of the group.

The social networking system may retrieve membership criteria associated with various groups to identify one or more social networking system users who satisfy the membership criteria. For example, upon receiving a request from a user of the social networking system to create a group for retired aircraft pilots having membership criteria that include a minimum age requirement of 60 and a previous occupation as an aircraft pilot, the social networking system may access profile information of social networking system users to identify users who satisfy the membership criteria. Examples of membership criteria associated with a group include demographic information (e.g., age, gender, or income level associated with members of the group), location information associated with members of the group (e.g., geographic locations of members' residences, workplaces, schools, etc.), answers to one or more questions posed by an administrator of the group (e.g., in a questionnaire that must be answered by prospective members), etc.

Information identifying users who satisfy membership criteria associated with a group may be stored by the social networking system for subsequent retrieval (e.g., upon identifying an opportunity to recommend a group to an identified user). For example, a username of a social networking system user who satisfies membership criteria associated with a group may be stored in association with a group name or identification number associated with the group. Alternatively, in the above example, information identifying the group associated with membership criteria satisfied by the user may be stored in association with a user profile associated with the user. The social networking system may identify social networking system users who satisfy membership criteria associated with a group on a periodic basis (e.g., once a week) or upon the occurrence of an event (e.g., upon receiving a request from a social networking system user to create the group or upon receiving a request from an administrator of the group to update the membership criteria).

Once the social networking system has identified one or more users of the social networking system who satisfy membership criteria associated with various groups, the social networking system may identify an opportunity to recommend that one of those users (a “viewing user”) join one or more of these groups. The social networking system may identify candidate groups that are eligible to be recommended to the viewing user based on information associated with each group having membership criteria that the viewing user satisfies and/or information associated with the viewing user that indicates a membership status of the user with respect to each group. For example, the social networking system retrieves information identifying members of various groups or information identifying various groups of which a viewing user is a member. In this example, the social networking system may first identify groups having membership criteria that the viewing user satisfies and then exclude groups of which the viewing user is already a member; the remaining groups are then identified as candidate groups that are eligible for recommendation to the viewing user. In some embodiments, the candidate groups identified by the social networking system include only groups of which the viewing user has never been a member. In other embodiments, the candidate groups identified by the social networking system include groups of which the viewing user is a former member, but is not currently a member (e.g., groups which the viewing user has left the membership).

The social networking system may compute affinity scores for the candidate groups, in which an affinity score indicates a predicted affinity of the viewing user for a candidate group. The affinity, in turn, may be predicted based on similarities between attributes associated with the viewing user and information maintained in the social networking system that is associated with a candidate group. For example, if a topic associated with a candidate group maintained in the social networking system is dissatisfaction with a presidential election, the social networking system may predict that a viewing user who previously expressed a preference for content items supporting a nominee who lost the election has a high affinity for the candidate group since an interest of the viewing user and a topic associated with the candidate group are very similar. In this example, the social networking system may then compute an affinity score for the candidate group that is proportional to the predicted affinity of the viewing user for the candidate group. The social networking system may determine similarities between attributes associated with a viewing user and information maintained in the social networking system that is associated with a candidate group by comparing metric spaces (e.g., using embeddings) or by using any other suitable method.

In some embodiments, the social networking system partitions groups into a geographical grid based on geographic locations associated with the groups and/or members of the groups; the grid is then used to predict the affinity of the viewing user for various candidate groups. For example, the social networking system may partition a geographical region into a grid and associate various groups with different portions of the grid based on geographic locations associated with each group. The social networking system may predict an affinity of the viewing user for a candidate group based on a distance between a geographic location associated with the viewing user and a portion of the geographical grid associated with the candidate group. For example, the affinity of the viewing user for a candidate group predicted by the social networking system is inversely proportional to the distance between a geographic location associated with the viewing user and a portion of the geographical grid associated with the candidate group.

The social networking system may select one or more candidate groups to recommend to the viewing user based on the predicted affinity of the viewing user for the candidate groups. For example, the social networking system may rank candidate groups based on the viewing user's predicted affinity for each candidate group, such that candidate groups that are associated with higher predicted affinities are ranked higher than those associated with lower predicted affinities. In this example, the social networking system may select candidate groups associated with at least a threshold ranking or at least a threshold affinity score for recommendation to the viewing user. A candidate group selected by the social networking system may be included in a recommendation that is presented to the viewing user.

Recommendations for the viewing user to join one or more groups may be presented to the viewing user in a recommendation unit. For example, the social networking system generates a scrollable recommendation unit for presentation to the viewing user that includes multiple groups recommended by the social networking system. A recommendation unit may be presented in conjunction with content items included in a feed of content items (e.g., in a newsfeed) or independently (e.g., along the right-hand side of a display area of a client device used by the viewing user to access the social networking system). A recommendation to join a group may include various elements such as a title of the group, a cover photo for the group, a short description of the group, topics associated with the group, an option to request to join the group (e.g., a “join” button), and contextual information that may describe why the group is being recommended. Examples of types of contextual information include a geographic location associated with a group, information describing the group (e.g., the group's similarity to another group of which the viewing user is a member, similarities in content posted by members of the group to content currently being viewed by the viewing user, a general description of the subject matter of the group, etc.), and information describing members of the group (e.g., a total number of members in the group, photos of friends of the viewing user who are members of the group, etc.).

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for recommending a group to a user of a social networking system based on an affinity of the user for an inferred topic associated with the group, in accordance with an embodiment.

FIG. 4 is an example of groups maintained in a social networking system partitioned into a geographical grid, in accordance with an embodiment.

FIG. 5 is an example user interface for presenting a recommendation to join one or more groups selected for recommendation to a user of a social networking system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

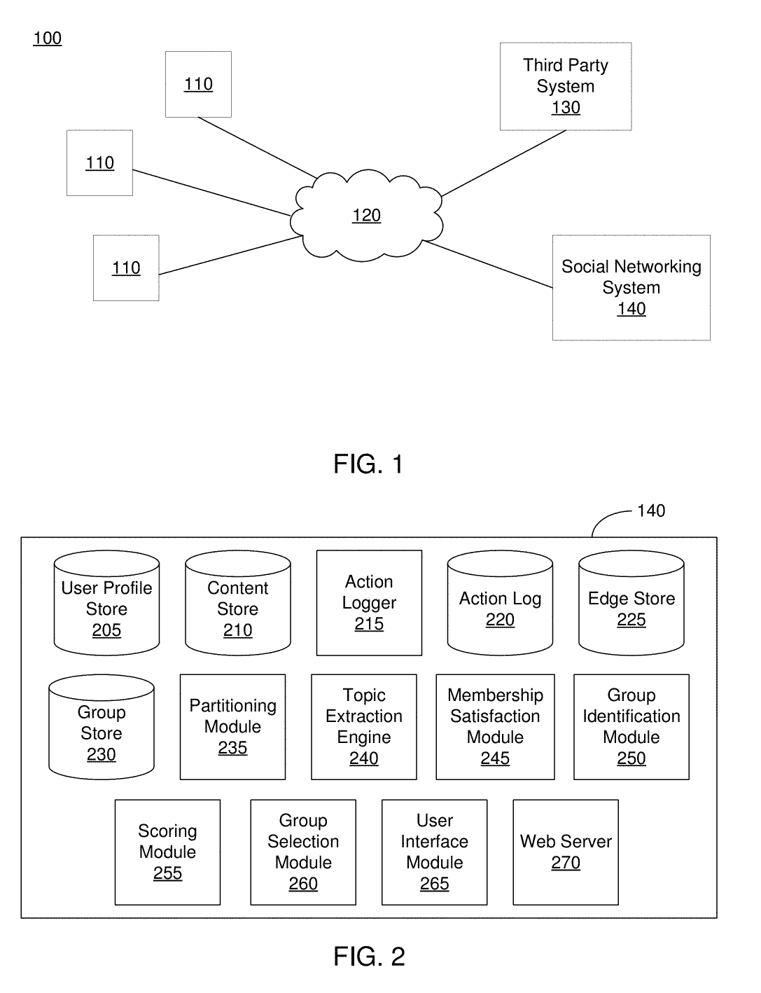

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein may be adapted to online systems systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

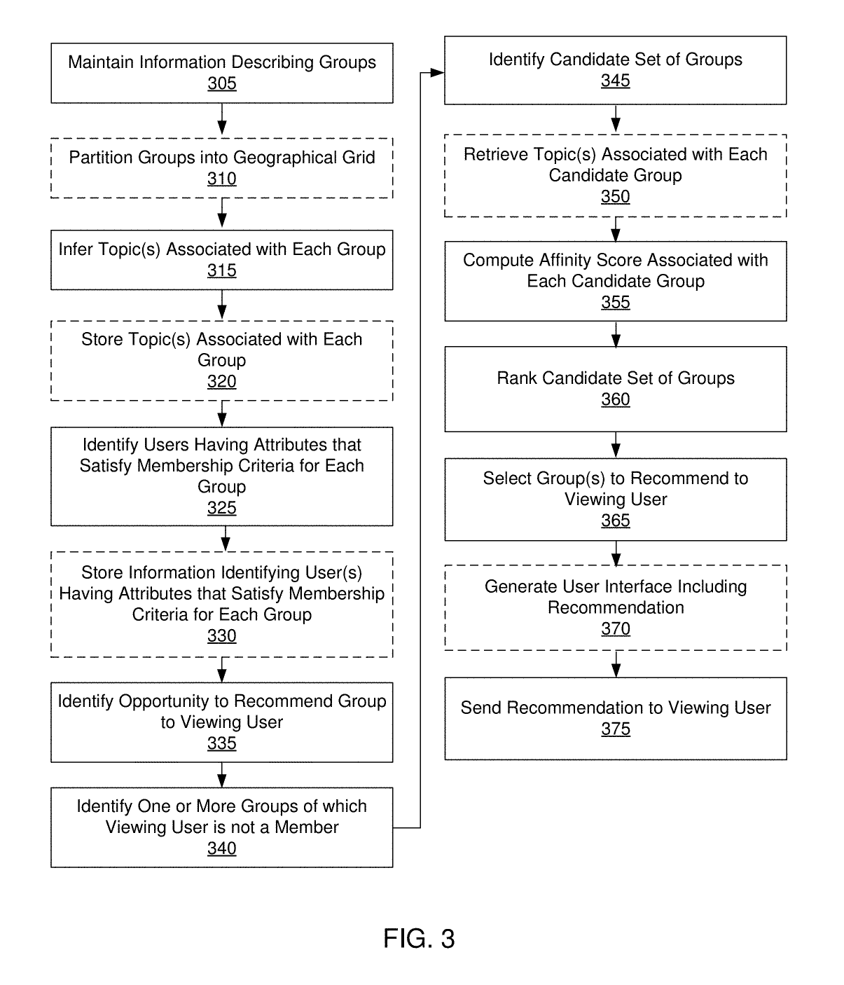

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, a group store 230, a partitioning module 235, a topic extraction engine 240, a membership satisfaction module 245, a group identification module 250, a scoring module 255, a group selection module 260, a user interface module 265, and a web server 270. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and also may include profile information inferred by the social networking system 140. In one embodiment, a user profile includes multiple data fields, each describing one or more user attributes of the corresponding social networking system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the social networking system users displayed in an image. A user profile in the user profile store 205 also may maintain references to actions by the corresponding user performed on content items in the content store 210 and stored in the action log 220.

In some embodiments, the user profile store 205 includes information describing one or more groups maintained in the social networking system 140 that are associated with various users of the social networking system 140. For example, the user profile store 205 includes information identifying one or more groups of which a user of the social networking system 140 is a member. As an additional example, the user profile store 205 includes information describing one or more groups having membership criteria that are satisfied by a social networking system user.

Information describing one or more groups associated with a user may be stored in association with a profile of the user in the user profile store 205. For example, a user profile includes information that identifies a group and describes a user associated with the profile as an administrator of the group. In this example, information stored in association with the user profile may include privileges of the user with respect to the group that are associated with the user's role as the administrator of the group and a date that the user became the administrator of the group. As an additional example, a user profile includes information that identifies multiple groups of which a user associated with the user profile is a member and the dates that the user joined the groups. In the above example, the user profile also may include information that describes groups of which the user is no longer a member and the dates that the user left the groups.

While user profiles in the user profile store 205 are frequently associated with individuals, allowing individuals to interact with each other via the social networking system 140, user profiles also may be stored for entities such as businesses or organizations. This allows an entity to establish a presence in the social networking system 140 for connecting and exchanging content with other social networking system users. The entity may post information about itself, about its products or provide other information to users of the social networking system 140 using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions in the social networking system 140, as well as actions in the third party system 130 that communicate information to the social networking system 140. Users may interact with various objects in the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the social networking system 140 as well as with other applications operating in the social networking system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects in the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page in the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

In some embodiments, information describing connections between groups and other objects maintained in the social networking system 140 (e.g., users) may be stored in association with edges in the edge store 225. Information stored in association with an edge may describe a relationship between a user and a group (e.g., a membership status of the user with respect to the group). For example, information stored in association with an edge between a user and a group indicates whether the user is a current member, a prospective member, or a former member of the group. In this example, if the information indicates that the user is a current member of the group, the information also may indicate when the user joined the group, the user's role within the group (e.g., whether the user is an administrator of the group), and the user's privileges with respect to the group (e.g., whether the user can approve membership requests to join the group). Alternatively, in the above example, if the information indicates that the user is a former member of the group, the information may indicate when the user left the group, the amount of time during which the user was a member of the group, the user's previous role within the group, etc.

In some embodiments, information stored in association with an edge may describe actions performed by a user with a group in the social networking system 140 (e.g., posting photos to a photo album associated with the group, participating in group chats, etc.). For example, the information stored in association with an edge may describe content posted by a user to a content feed associated with a group and a time at which the content was posted to the content feed. As an additional example, information stored in association with an edge may describe messages posted to a message board associated with a group that were viewed by a user, the times at which the user viewed each message, etc.

The social networking system 140 may retrieve information stored in association with an edge in the edge store 225 to make determinations associated with one or more groups. For example, information stored in association with an edge may be retrieved to determine whether a user is a current member or a former member of a group. As an additional example, various types of actions performed by a user with a group in the social networking system 140 may be identified based on information stored in association with an edge in the edge store 225.

The edge store 225 also stores information about edges, such as affinity scores for objects, interests, and other users. Affinity scores, or “affinities,” may be computed by the social networking system 140 over time to approximate a user's interest in an object or in another user in the social networking system 140 based on the actions performed by the user. A user's affinity may be computed by the social networking system 140 over time to approximate a user's interest in an object, a topic, or another user in the social networking system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The group store 230 stores or maintains (e.g., as shown in step 305 of FIG. 3) information associated with various groups. Information associated with a particular group may be stored in the group store 230 in association with information identifying the group. For example, information associated with a group (e.g., information identifying members of the group and a geographic location associated with the group) is stored in the group store 230 in association with a group name or a group identification number.

Information associated with a group that may be stored in the group store 230 may describe membership criteria that must be satisfied by social networking system users who are members of the group. Membership criteria may include attributes for members of a group. Examples of attributes for members of a group include demographic/biographic information (e.g., an age, a gender, an income level, a workplace, a credential, an occupation, or a marital status associated with each member of the group); location information associated with members of the group (e.g., geographic locations of members' residences, workplaces, schools attended, hometowns, etc.); answers to one or more questions provided by an administrator of the group (e.g., in a questionnaire that must be answered by prospective members); a hobby or an interest shared by group members (e.g., a favorite sport, sports team, activity, celebrity, etc.); an art, an artist, or an entertainment format in which group members share an interest (e.g., a movie, an actor, a band, a song, a music genre, a book, an author, a video game, a board game, etc.); and a political view, a religious view, a philosophy, a concept, or any other suitable characteristic common to group members.

Information associated with a group that may be stored in the group store 230 also may describe content posted by one or more members of the group. Examples of content posted by a member of a group include photos posted to a photo album associated with the group; content (e.g., videos, images, text, etc.) uploaded by group members to a page maintained in the social networking system 140 that is associated with the group; messages posted to a message board associated with the group; events posted to a calendar associated with the group; files that may be viewed and edited by members of the group; and content items posted to a content feed associated with the group.

In some embodiments, information associated with a group that is stored in the group store 230 may describe one or more topics of interest (“topics”) shared by members of a group. A topic associated with a group may be associated with attributes for members of the group. For example, if members of a group are teammates in a soccer league, topics associated with the group may include a name of the team to which the teammates belong, a name of the soccer league to which the team belongs, and the sport of soccer. As an additional example, if members of a group share a common interest or a common sentiment, a topic associated with the group may describe the interest/sentiment (e.g., opposition to a proposed zoning ordinance). A topic associated with a group also may be associated with content posted to the social networking system 140 by a member of the group. For example, if at least a threshold percentage of members of a group post content to a content feed associated with the group indicating a shared political view about immigration, a topic associated with the group may describe the political view. As an additional example, if users of a group post photos to a photo album associated with the group, in which at least a threshold percentage of the photos are captioned with the keywords “dog,” “puppy,” or “canine,” a topic associated with the group may include the canine animal species. One or more topics associated with a group may be inferred by the topic extraction engine 240, as described below, and subsequently stored in the group store 230 in association with information identifying the group.

Information associated with a group that is stored in the group store 230 in association with information identifying the group may be specific to individual users associated with the group and their relationship to the group. Information specific to a user associated with a group may include information identifying the user, contact information for the user, and any other suitable information that may be specific to the user. For example, information specific to a user associated with a group may include a username associated with the user, a profile image associated with the user, and an email address of the user, which are stored in a group mailing list in association with information identifying the group in the group store 230. Information specific to a user that is stored in the group store 230 may include a membership status of the user with respect to a group, a role of the user within the group, and one or more privileges of the user with respect to the group. For example, information describing a relationship between a user and a group may indicate whether the user is a current member of the group, a former member of the group, or a user whose membership in the group is pending approval. In this example, if information describing the relationship between the user and the group indicates that the user is a current member of the group, the information also may indicate one or more privileges of the user with respect to the group (e.g., whether the user can set a privacy setting associated with the group or manage content posted to a content feed associated with the group).

Information specific to a user that is stored in the group store 230 also may indicate whether the user satisfies membership criteria associated with a group. For example, usernames associated with social networking system users having attributes that satisfy membership criteria associated with a group may be stored in association with information identifying the group. In the above example, the group store 230 also may store information indicating which membership criteria and/or how many of the membership criteria are satisfied by each user, a time at which each user's attributes were compared to the membership criteria associated with the group, etc.

Information associated with a group that is stored in the group store 230 in association with information identifying the group also may include information that generally applies to the group and/or to all members of the group. Information that generally applies to all members of a group may include information that may be used to identify individual groups. Examples of such information include a group photo/image, a group name, a geographic location, and a general description of the group. For example, a group named “Tri-Valley Siberian Husky Meetup” is described as owners of dogs of the Siberian Husky breed who are interested in meeting with other owners and their dogs for various activities in the Tri-Valley area of California. In this example, in addition to being associated with the group name and group description, the group is also associated with a geographic location corresponding to the Tri-Valley area of California and a group photo of its members.

In some embodiments, information that is stored in association with information identifying a group may include one or more privacy settings associated with the group. The social networking system 140 may determine whether a social networking system user may join a group and/or view content associated with the group based on a privacy setting associated with the group. For example, groups may be “open,” such that anyone is allowed to join and view content associated with the group, or “closed,” such that a user is required to request to join the group or must be invited by an existing group member to join the group and some content associated with the group may only be viewed by members of the group. As an additional example, a group may be “secret,” such that a user may become a member only by invitation by an existing group member and information associated with the group may only be viewed by members of the group. The group store 230 is further described below in conjunction with FIG. 3).

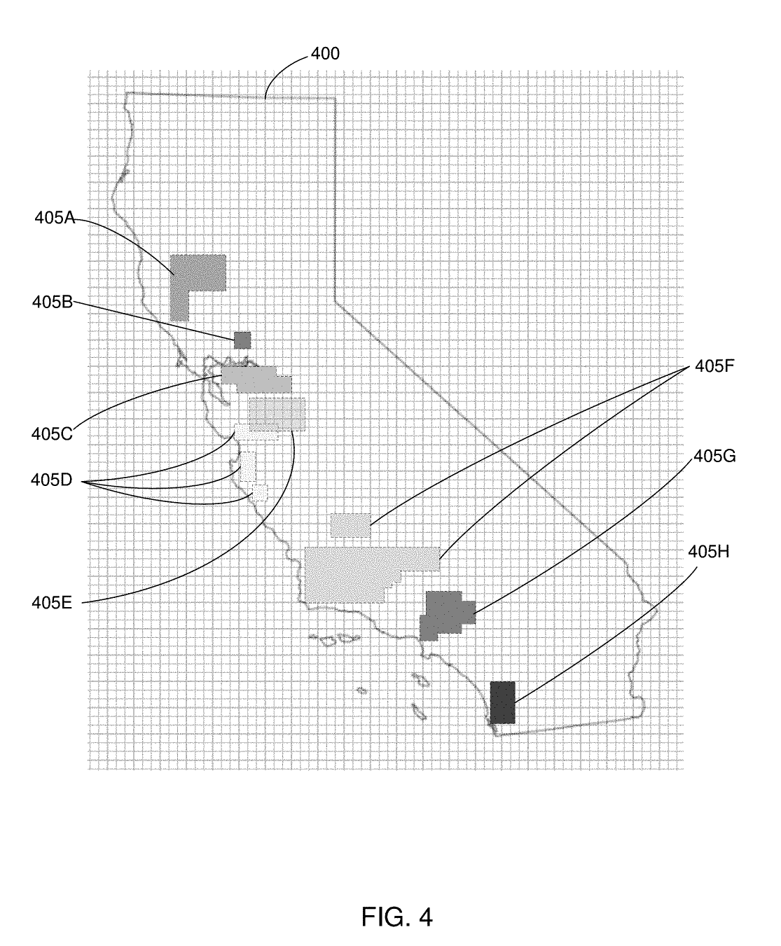

In some embodiments, the partitioning module 235 partitions (e.g., as shown in step 310 of FIG. 3) groups maintained in the social networking system 140 into different portions of a geographical grid based on geographic locations associated with the groups. For example, the partitioning module 235 may partition a geographical region corresponding to the state of New York into different portions of a geographical grid using gridlines that correspond to longitude and latitude lines that cross the state. In this example, if a group is associated with a fraternity having multiple chapters associated with different universities in New York, the partitioning module 235 may associate multiple portions of the geographical grid with the group based on the geographic locations associated with the university campuses. In some embodiments, the partitioning module 235 also may partition groups into different portions of the geographical grid based on geographic locations associated with members of the groups. For example, the partitioning module 235 may partition a geographical region corresponding to the country of China into different portions of a geographical grid using gridlines that run north to south and east to west and are spaced 50 miles apart. In this example, if the majority of members of a group sharing a political view live in a particular province in China, the partitioning module 235 may associate the group with portions of the geographical grid that correspond to the province. The functionality of the partitioning module 235 is further described below in conjunction with FIGS. 3 and 4.

The social networking system 140 includes a topic extraction engine 240, which identifies one or more topics associated with objects in the content store 210. To identify topics associated with content items, the topic extraction engine 240 identifies anchor terms included in a content item and determines a meaning of the anchor terms as further described in U.S. patent application Ser. No. 13/167,701, filed Jun. 24, 2011, published as U.S. Patent Publication No. 2012/0331063, which is hereby incorporated by reference in its entirety. For example, the topic extraction engine 240 determines one or more topics associated with a content item maintained in the content store 210. The one or more topics associated with a content item are stored and associated with an object identifier corresponding to the content item. In various embodiments, associations between object identifiers and topics are stored in the topic extraction engine 240 or in the content store 210 to simplify retrieval of one or more topics associated with an object identifier or retrieval of object identifiers associated with a specified topic. Structured information associated with a content item also may be used to extract a topic associated with the content item.

The topic extraction engine 240 may infer (e.g., as shown in step 315 of FIG. 3) a topic associated with a group based on content posted to the social networking system 140 by a member of the group in association with the group. For example, the topic extraction engine 240 may infer that a group is associated with the topic of baseball if the topic extraction engine 240 identifies “baseball” to be an anchor term associated with at least a threshold number or percentage of content items posted by members of the group in association with the group (e.g., to a content feed associated with the group). As an additional example, the topic extraction engine 240 may infer that a group is associated with the topic of a particular beach if metadata associated with photos posted by at least a threshold percentage of members to a photo album associated with the group are associated with a geographic location corresponding to the beach.

The topic extraction engine 240 also may infer a topic associated with a group based on attributes for members of the group. In some embodiments, the topic extraction engine 240 may access the user profile store 205 to retrieve information stored in association with user profiles of members of a group and infer one or more topics associated with the group based on the retrieved information. For example, the topic extraction engine 240 may access information stored in association with user profiles of members of a group describing the members' educational backgrounds and occupations; if the anchor term “law school,” appears in at least a threshold percentage of the members' educational backgrounds and the anchor terms “attorney,” or “lawyer” appear in at least a threshold percentage of the members' occupations, the topic extraction engine 240 may infer the group is associated with the topics of law and lawyers/attorneys.

In some embodiments, the topic extraction engine 240 also may infer a topic associated with a group based on additional types of information associated with the group. For example, the topic extraction engine 240 may retrieve information describing a title associated with a group (e.g., from the group store 230) and infer a topic associated with the group based on one or more keywords included in the title. As an additional example, if the topic extraction engine 240 retrieves information describing members of a group as “Singles who enjoy bar hopping in Berkeley, Calif.,” the topic extraction engine 240 may infer topics associated with the group that include a marital status corresponding to single, an activity corresponding to bar hopping, and a geographic location corresponding to Berkeley, Calif.

The topic extraction engine 240 may infer a topic associated with a group using a machine-learning algorithm based on content posted by members of the group in association with the group. For example, a model is trained to predict whether a content item is associated with the topic of fashion using a machine-learning algorithm based on information included in a set of training content items that are associated with the topic of fashion (e.g., names of fashion designers, brands of apparel, names of schools of fashion design, and keywords associated with the topic of fashion) and information included in an additional set of training content items that are not associated with the topic of fashion. In this example, the topic extraction engine 240 may infer that a group is associated with the topic of fashion if the model predicts that at least a threshold percentage of content items posted by members of the group to a content feed associated with the group are associated with the topic of fashion.

The topic extraction engine 240 also may infer a topic associated with a group using a machine-learning algorithm based on attributes for members of the group or any other suitable information associated with the group. For example, a machine-learning algorithm is used to train a model to predict a likelihood that a group is associated with the topic of law enforcement using training data describing attributes associated with members of groups that are associated with the topic of law enforcement (e.g., ages, genders, educational backgrounds, occupations, and interests of the users and actions performed by the users with objects maintained in the social networking system 140) and additional training data describing the same attributes associated with members of groups that are not associated with the topic of law enforcement. In this example, the model predicts a percentage likelihood that a group is associated with the topic of law enforcement based on attributes for members of the group; the topic extraction engine 240 then infers that the group is associated with the topic if the percentage likelihood is at least a threshold percentage and does not infer that the group is associated with the topic if the percentage likelihood is less than the threshold percentage. The functionality of the topic extraction engine 240 is further described below in conjunction with FIG. 3.

The membership satisfaction module 245 identifies (e.g., as shown in step 325 of FIG. 3) one or more users of the social networking system 140 who have attributes that satisfy the membership criteria for a group. To identify a user of the social networking system 140 who has attributes that satisfy the membership criteria for a group, the membership satisfaction module 245 may retrieve membership criteria associated with the group (e.g., by accessing the group store 230) and attributes associated with the user (e.g., by accessing the user profile store 205, the action log 220, and/or the edge store 225). The membership satisfaction module 245 may then compare the membership criteria associated with the group to the attributes associated with the user to determine whether the attributes associated with the user satisfy the membership criteria associated with the group. For example, if a group is associated with membership criteria that describe social networking system users between 12 and 17 years old and a geographic location of Chicago, Ill., the membership satisfaction module 245 may determine that a user who is 16 years old and who currently lives in Chicago, Ill. satisfies the membership criteria of the group. In the above example, if the user is 20 years old, the membership satisfaction module 245 may determine that the user does not satisfy the membership criteria of the group even though the user lives in and/or works in Chicago, Ill.

The membership satisfaction module 245 may identify users of the social networking system 140 who have attributes that satisfy the membership criteria associated with a group periodically and/or upon the occurrence of an event. For example, the membership satisfaction module 245 may identify users who have attributes that satisfy membership criteria associated with a group every two weeks. As an additional example, the membership satisfaction module 245 may identify users who have attributes that satisfy membership criteria associated with a group upon the creation of the group or if an administrator of the group updates the membership criteria associated with the group.

In some embodiments, the membership satisfaction module 245 may store (e.g., as shown in step 330 of FIG. 3) information describing a user who has attributes that satisfy the membership criteria associated with a group. For example, information identifying a user who has attributes that satisfy membership criteria associated with a group may be stored in association with information identifying the group (e.g., in the group store 230). Additionally or alternatively, in the above example, information identifying the group may be stored in association with a user profile associated with the user (e.g., in the user profile store 205). The functionality of the membership satisfaction module 245 is further described below in conjunction with FIG. 3.

The group identification module 250 may identify (e.g., as shown in step 340 of FIG. 3) one or more groups of which a viewing user is not a member based on stored information associated with the groups and the viewing user. For example, the group identification module 250 may retrieve information stored in association with a profile of a viewing user of the social networking system 140 identifying one or more groups of which the viewing user is a member (e.g., based on a group name or other identifier). In the above example, the group identification module 250 may access the group store 230 and identify one or more groups of which the viewing user is not a member (i.e., groups that were not identified in the information stored in association with the profile of the viewing user). As an additional example, the group identification module 250 accesses the edge store 225 to determine whether a connection exists between a group and a viewing user; if no connection exists, the group identification module 250 determines that the viewing user is not a member of the group. In this example, if a connection exists, the group identification module 250 retrieves information stored in association with the connection and determines if the viewing user is a member of the group based on the retrieved information.

The group identification module 250 may identify one or more groups of which a viewing user is not a member subject to privacy settings associated with the groups. For example, the group identification module 250 may identify groups that allow anyone to join (“open” groups) or groups that require a user to request to join (“closed” groups) as groups of which a viewing user is not a member. As an additional example, the group identification module 250 may not identify groups that require a user to be invited by an existing member in order to become a member (“secret” groups) as groups of which a viewing user is not a member.

In various embodiments, the group identification module 250 may identify groups of which the viewing user is not a member based on the viewing user's membership statuses with respect to the groups. For example, when identifying groups of which the viewing user is not a member, groups identified by the group identification module 250 may include groups of which the viewing user was never a member, as well as groups of which the viewing user is a former member, but is not a current member. As an additional example, the group identification module 250 may not identify a group as being among the groups of which the viewing user is not a member if the viewing user's membership in the group is pending (e.g., the viewing user has requested to join the group, but the request has been neither approved nor denied). The functionality of the group identification module 250 is further described below in conjunction with FIG. 3.

The scoring module 255 computes (e.g., as shown in step 355 of FIG. 3) affinity scores associated with candidate groups. An affinity score associated with a candidate group indicates a predicted affinity of a viewing user for the candidate group. The scoring module 255 may compute an affinity score associated with a candidate group based at least in part on a measure of similarity between a topic associated with the candidate group and one or more attributes associated with a viewing user or any other suitable information associated with the viewing user that may indicate an affinity of the viewing user for the candidate group. For example, the scoring module 255 computes an affinity score associated with a candidate group associated with the topic of silent films (e.g., retrieved from the group store 230) based on a measure of similarity between attributes associated with a viewing user (e.g., retrieved from the user profile store 205, the edge store 225, and/or the action log 220) and the topic of silent films. In this example, the scoring module 255 predicts that the viewing user has a high affinity for silent films if profile information indicates that the viewing user's favorite movie is a silent film or that the viewing user's favorite actor is a silent film actor and if the viewing user has frequently clicked on and commented on content items including the names of silent film actors. Accordingly, in this example, the scoring module 255 computes a high affinity score associated with the candidate group that is proportional to the predicted affinity of the viewing user for the candidate group. Alternatively, in the above example, the scoring module 255 predicts that the viewing user has a low affinity for silent films if profile information does not indicate that the viewing user's favorite movie is a silent film or that the viewing user's favorite actor is a silent film actor and if the viewing user has never clicked on or commented on content items including the names of silent film actors. Therefore, in this example, the scoring module 255 computes a low affinity score associated with the candidate group that is proportional to the predicted affinity of the viewing user for the candidate group.

The scoring module 255 may determine similarities between attributes associated with a viewing user and information maintained in the social networking system 140 that is associated with a candidate group by comparing metric spaces (e.g., using embeddings) or any other suitable method. For example, the scoring module 255 may use a metric space approach to quantify a similarity between an attribute associated with a viewing user and a topic associated with a candidate group (e.g., using a pairwise distance measure). In the above example, the scoring module 255 then computes an affinity score associated with the content item that is proportional to the measure of similarity.

In some embodiments, the scoring module 255 may compute an affinity score associated with a candidate group based on a distance between a geographic location associated with a viewing user and a portion of a geographical grid associated with the candidate group. For example, the affinity of the viewing user for a candidate group predicted by the scoring module 255 is inversely proportional to the distance between a geographic location associated with the viewing user and a portion of a geographical grid associated with the candidate group. In this example, the scoring module 255 computes an affinity score associated with the candidate group that is proportional to the predicted affinity of the viewing user for the candidate group.

In various embodiments, an affinity score associated with a candidate group also may be computed by the scoring module 255 based on other types of information associated with a viewing user and the candidate group that may indicate an affinity of the viewing user for the candidate group. For example, the scoring module 255 may compute an affinity score associated with a candidate group based on a number of members of the group who are connected to a viewing user (e.g., friends or family members of the viewing user). In this example, the affinity score computed for the candidate group may be proportional to the number of group members who are connected to the viewing user. As an additional example, the scoring module 255 may compute an affinity score associated with a candidate group based on a measure of similarity between members of the candidate group and a viewing user, such that the affinity score is proportional to the measure of similarity. The functionality of the scoring module 255 is further described below in conjunction with FIG. 3.

The group selection module 260 selects (e.g., as shown in step 365 of FIG. 3) one or more groups maintained in the social networking system 140 to recommend to a viewing user of the social networking system 140. The group selection module 260 may select the group(s) based at least in part on affinity scores associated with candidate groups eligible to be recommended to the viewing user. In one embodiment, the group selection module 260 ranks (e.g., as shown in step 360 of FIG. 3) candidate groups based on their affinity scores and selects one or more groups for recommendation to the viewing user based on a position of each candidate group in the ranking. For example, the group selection module 260 ranks multiple candidate groups based on their affinity scores, such that the highest ranked group is associated with the highest affinity score, the second highest ranked group is associated with the second highest affinity score, etc. In this example, the group selection module 260 then selects one or more of the highest ranked groups for recommendation to a viewing user. In another embodiment, the group selection module 260 selects one or more candidate groups having at least a threshold affinity score for recommendation to the viewing user. In the above example, if the two highest ranked groups are associated with at least a threshold affinity score, both of these groups are selected for recommendation to the viewing user.

In some embodiments, the group selection module 260 also may select one or more groups to recommend to a viewing user based on the viewing user's membership status with respect to various groups. For example, even if a viewing user of the social networking system 140 satisfies membership criteria associated with a group, the group selection module 260 does not rank the group and/or select the group for recommendation to the viewing user if the viewing user is already a member of the group. In the above example, the group selection module 260 also may not rank the group and/or select the group for recommendation to the viewing user if the viewing user is a former member of the group or if the viewing user's membership in the group is pending. The functionality of the group selection module 260 is further described below in conjunction with FIG. 3.

The user interface module 265 generates (e.g., as shown in step 370 of FIG. 3) a user interface that recommends one or more groups selected for recommendation to a viewing user. For example, the user interface module 265 generates a recommendation unit that indicates that a viewing user to whom the recommendation unit is to be presented will likely have an interest in one or more groups described by information included in the recommendation unit. In this example, the recommendation unit may include a window viewing area and a scroll bar that allows the viewing user to move the information describing each group being recommended into the window viewing area. In some embodiments, the selected groups included in the user interface may be ordered based on the affinity scores associated with each selected group. For example, a group associated with a highest affinity score may be included in a most prominent position of the user interface, while a group associated with a second highest affinity score may be included in a second most prominent position of the user interface, etc.

Various types of information may be included in the user interface to describe each group being recommended to a viewing user. Information describing a group may include a title of the group, a cover photo for the group, a short description of the group, topics associated with the group, etc. In some embodiments, the user interface also may include contextual information describing why the group is being recommended to a viewing user. For example, a recommendation unit may explain that a group is being recommended to a viewing user based on a geographic location associated with the group that is close to a geographic location associated with the viewing user or based on similarities between the group and another group of which the viewing user is a member. As an additional example, a recommendation unit may explain that a group is being recommended to a viewing user based on similarities between content currently being viewed by the viewing user and content posted by members of the group and based on information describing members of the group (e.g., information identifying friends of the viewing user who are members of the group).

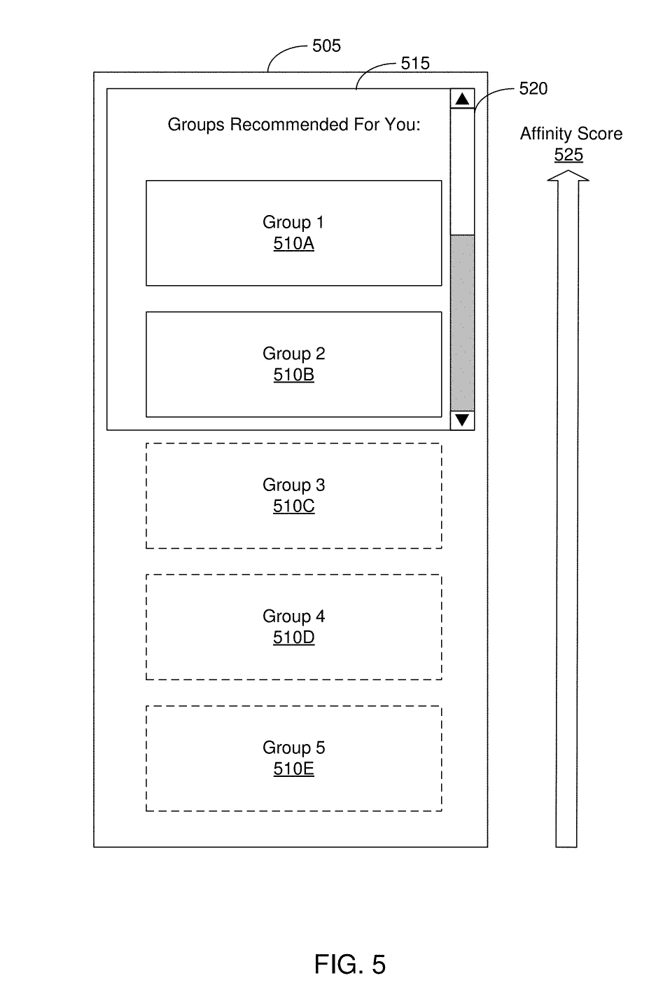

The user interface generated by the user interface module 265 may allow a viewing user to submit a request to join a group included in the user interface or to request to view additional information associated with a group included in the user interface. For example, a recommendation unit may include information describing multiple groups selected by the group selection module 260 (e.g., a name, a group photo, and a description of each group), in which information describing each group is presented in conjunction with a “join” button that allows a viewing user to submit a request to join the group by clicking on the button. In this example, the information describing each group also may be presented in conjunction with a “learn more” button; in response to receiving information indicating that the viewing user has clicked on this button, the social networking system 140 may present the viewing user with a page for the group maintained in the social networking system 140. The functionality of the user interface module 265 is further described below in conjunction with FIGS. 3 and 5.

The web server 270 links the social networking system 140 via the network 120 to the one or more client devices 110, as well as to the third party system 130 and/or one or more third party systems. The web server 270 serves web pages, as well as other content, such as JAVA®, FLASH®, XML and so forth. The web server 270 may receive and route messages between the social networking system 140 and the client device 110, for example, instant messages, queued messages (e.g., email), text messages, short message service (SMS) messages, or messages sent using any other suitable messaging technique. A user may send a request to the web server 270 to upload information (e.g., images or videos) that are stored in the content store 210. Additionally, the web server 270 may provide application programming interface (API) functionality to send data directly to native client device operating systems, such as IOS®, ANDROID™, WEBOS® or BlackberryOS.

### Recommending a Group to a User of a Social Networking System

FIG. 3 is a flow chart of a method for recommending a group to a user of a social networking system based on an affinity of the user for an inferred topic associated with the group according to one embodiment. In other embodiments, the method may include different and/or additional steps than those shown in FIG. 3. Additionally, steps of the method may be performed in a different order than the order described in conjunction with FIG. 3.

The social networking system 140 maintains 305 (e.g., in the group store 230) information describing various groups. Information associated with a particular group may be stored in association with information identifying the group. For example, information associated with a group (e.g., membership criteria for the group, information identifying members of the group, and information describing a geographic location associated with the group) is stored in the group store 230 in association with a group name, a group identification number, or any suitable identifier for the group.

Each group maintained 305 in the social networking system 140 may be associated with one or more users of the social networking system 140 (e.g., one or more members of the group). For example, information stored in the group store 230 may include usernames associated with various users associated with a group and information indicating whether each user associated with the group is a current member of the group, a former member of the group, or a user whose membership in the group is pending approval. As an additional example, each group may be associated with a group mailing list that includes the usernames and contact information for each member of the group.

Each group also may have membership criteria that must be satisfied by social networking system users who are members of the group. Membership criteria may include attributes for members of a group. In some embodiments, attributes for members of a group include demographic or biographic information, such as an age, a gender, an income level, a workplace, a credential, an occupation, or a marital status. Attributes for members of a group also may describe a geographic location associated with members of the group, such as the geographic location of each group member's residence, workplace, school, hometown, etc. In various embodiments, answers to one or more questions provided by an administrator of a group may serve as attributes for members of the group. For example, users who have requested to join a group must provide answers to a questionnaire; the answers serve as attributes for members of the group, such that particular answers must be provided by users in order for the users to become members of the group. A hobby or an interest, such as an art form, an artist, or an entertainment format also may serve as attributes for members of a group. For example, members of a group may share a common interest in a movie, an actor, a band, a song, a music genre, a book, an author, a video game, a board game, etc. In some embodiments, attributes for members of a group may include a political view, a religious view, a philosophy, a concept, or any other suitable characteristic common to group members.

Each group maintained 305 in the social networking system 140 may be associated with content posted to the social networking system 140 by one or more members of the group in association with the group. In some embodiments, content that may be posted by a member of a group in association with the group include photos posted to a photo album associated with the group, content (e.g., videos, images, text, etc.) uploaded by group members to a page associated with the group maintained in the social networking system 140, and messages posted to a message board associated with the group. In additional embodiments, content posted by a member of a group that may be stored in association with information identifying the group also may include events posted to a calendar associated with the group, files that may be viewed and edited by members of the group, and content items posted to a content feed associated with a group.

In some embodiments, the social networking system 140 partitions 310 (e.g., using the partitioning module 235) groups maintained 305 in the social networking system 140 into different portions of a geographical grid. As shown in the example of FIG. 4, the social networking system 140 may partition 310 a geographical region corresponding to the state of California into a grid 400 using horizontal and vertical gridlines. Different portions of the grid 400 may then be associated with various groups 405A-H based on geographic locations associated with each group 405A-H. A group 405A-H may be associated with one or more cities, counties, or any other suitable geographic location within California, such that the portion of the grid 400 to which the group 405A-H is associated corresponds to its geographic location. For example, group 405B of the grid 400 corresponds to the city of Vacaville, Calif., while group 405C of the grid 400 corresponds to the county of Contra Costa County, Calif.

A geographic location associated with a group 405A-H may correspond to a geographic location associated with the entire group 405A-H. For example, if a group 405D is associated with a religion having multiple churches across California, the social networking system 140 may associate multiple portions of the geographical grid 400 with the group 405D based on the geographic locations of the cities in which the churches are located. Additionally, a geographic location associated with a group 405A-H may correspond to one or more geographic locations associated with one or more members of the group 405A-H. For example, if the majority of members of a group 405F of college football fans live in a particular county in California, the social networking system 140 may associate the group 405F with portions of the geographical grid 400 that correspond to the county or with portions of the geographical grid 400 that correspond to the cities in which the group members reside.

Referring back to FIG. 3, the social networking system 140 infers 315 (e.g., using the topic extraction engine 240) one or more topics associated with each of the groups. The social networking system 140 may infer 315 a topic associated with a group based at least in part on the content posted to the social networking system 140 by a member of the group in association with the group. For example, the social networking system 140 may infer 315 that a group is associated with the topic of golfing if the social networking system 140 identifies anchor terms associated with golfing (e.g., “golf,” “tee time,” “putting,” etc.) to be associated with at least a threshold number or percentage of content items posted by members of the group in association with the group (e.g., to a content feed associated with the group). As an additional example, the social networking system 140 may infer 315 that a group is associated with the topic of a particular park if metadata associated with photos posted by at least a threshold percentage of members to a photo album associated with the group are associated with a geographic location corresponding to the park.

The social networking system 140 also may infer 315 a topic associated with a group based at least in part on attributes for members of the group. In some embodiments, the social networking system 140 may retrieve information (e.g., from the user profile store 205) stored in association with user profiles of members of a group and infer 315 one or more topics associated with the group based on the retrieved information. For example, based on information stored in association with user profiles of members of a group (e.g., from the user profile store 205) the social networking system 140 may determine that members of a group are friends or family members, colleagues collaborating on a publication, students who are in the same class, or users who share a common interest or a common sentiment (e.g., supporters of a mayoral candidate). As an additional example, to infer 315 a topic associated with a group, the social networking system 140 may access information stored in association with user profiles of members of the group describing the members' educational backgrounds and occupations. In the above example, if the anchor term “medical school,” appears in at least a threshold percentage of the members' educational backgrounds and the anchor terms “doctor,” or “physician” appear in at least a threshold percentage of the members' occupations, the social networking system 140 may infer 315 that the group is associated with the topics of medicine and doctors/physicians.

In some embodiments, the social networking system 140 also may infer 315 a topic associated with a group based on additional types of information associated with the group. For example, the social networking system 140 may retrieve information describing a title associated with a group (e.g., from the group store 230) and infer 315 a topic associated with the group based on one or more keywords included in the title. As an additional example, if the social networking system 140 retrieves information describing members of a group as “Yogis who practice Hatha yoga in Phoenix, Ariz.,” the social networking system 140 may infer 315 topics associated with the group that include an activity corresponding to Hatha yoga, and a geographic location corresponding to Phoenix, Ariz.

In various embodiments, the social networking system 140 may infer 315 a topic associated with a group using a machine-learning algorithm. The social networking system 140 may infer 315 a topic associated with a group using a machine-learning algorithm based on content posted by members of the group in association with the group. For example, the social networking system 140 trains a model to predict whether a content item is associated with the topic of skateboarding using a machine-learning algorithm based on information included in a set of training content items that are associated with the topic of skateboarding (e.g., names of popular skateboarding competitions and competitors, brands of skateboards, names and locations of skate parks, and keywords associated with the topic of skateboarding) and information included in an additional set of training content items that are not associated with the topic of skateboarding. In this example, the social networking system 140 may infer 315 that a group is associated with the topic of skateboarding if the model predicts that at least a threshold percentage of content items posted by members of the group to a content feed associated with the group are associated with the topic of skateboarding.

The social networking system 140 also may infer 315 a topic associated with a group using a machine-learning algorithm based on attributes for members of the group or any other suitable information associated with the group. For example, a machine-learning algorithm is used to train a model to predict a likelihood that a group is associated with the topic of street art using training data describing attributes associated with members of groups that are associated with the topic of street art (e.g., ages, genders, educational backgrounds, occupations, and interests of the users and actions performed by the users with objects maintained in the social networking system 140) and additional training data describing the same attributes associated with members of groups that are not associated with the topic of street art. In this example, the model predicts a percentage likelihood that a group is associated with the topic of street art based on attributes for members of the group; the social networking system 140 then infers 315 that the group is associated with the topic if the percentage likelihood is at least a threshold percentage and does not infer 315 that the group is associated with the topic if the percentage likelihood is less than the threshold percentage.

In some embodiments, the social networking system 140 stores 320 the topic(s) associated with each group. A topic associated with a group may be stored 320 in association with information identifying the group. For example, the social networking system 140 may store 320 a topic associated with a group in association with a name of the group or an identification number associated with an account for the group in the group store 230.

The social networking system 140 identifies 325 (e.g., using the membership satisfaction module 245) one or more users of the social networking system 140 who have attributes that satisfy the membership criteria for each group. To identify 325 a user of the social networking system 140 who has attributes that satisfy the membership criteria for a group, the social networking system 140 may retrieve membership criteria associated with the group (e.g., by accessing the group store 230) and attributes associated with the user (e.g., by accessing the user profile store 205, the action log 220, and/or the edge store 225). The social networking system 140 may then compare the membership criteria associated with the group to the attributes associated with the user to determine whether the attributes associated with the user satisfy the membership criteria associated with the group. For example, if a group is associated with membership criteria that describe social networking system users and includes an age of at least 21 years old and a geographic location of Manhattan, N.Y., the social networking system 140 may determine that a user who is 25 years old who currently lives in Manhattan, N.Y. satisfies the membership criteria for the group. In the above example, if the user is 19 years old, the social networking system 140 may determine that the user does not satisfy membership criteria for the group even though the user lives in, works in, or attends a school in Manhattan, N.Y.

The social networking system 140 may identify 325 users of the social networking system 140 who have attributes that satisfy the membership criteria associated with a group periodically and/or upon the occurrence of an event. For example, the social networking system 140 may identify 325 users who have attributes that satisfy membership criteria associated with a group every week. As an additional example, the social networking system 140 may identify 325 users who have attributes that satisfy membership criteria associated with a group upon creation of the group or if an administrator of the group updates the membership criteria associated with the group.

In various embodiments, the social networking system 140 may store 330 (e.g., using the membership satisfaction module 245) information identifying the one or more users who have attributes that satisfy the membership criteria associated with each group. For example, the social networking system 140 may store 330 information identifying a user who has attributes that satisfy membership criteria associated with a group in association with information identifying the group (e.g., in the group store 230). Additionally or alternatively, in the above example, the social networking system 140 may store 330 information identifying the group in association with a user profile associated with the user (e.g., in the user profile store 205).

The social networking system 140 identifies 335 an opportunity to recommend that a viewing user of the one or more users join one or more of the groups. For example, the social networking system 140 identifies 335 an opportunity to recommend that the viewing user join a group upon receiving login credentials from the viewing user that match a username and a password associated with a user account maintained in the social networking system 140. As an additional example, the social networking system 140 may identify 335 an opportunity to recommend that the viewing user join one or more groups upon receiving a request to present a newsfeed to the viewing user. In the above example, the social networking system 140 may include a recommendation that the viewing user join the one or more groups in a recommendation unit that is included in the newsfeed or in a separate window that is presented in conjunction with the newsfeed.

The viewing user is associated with one or more attributes. As described above, attributes associated with the viewing user may include information associated with the viewing user that is stored in the user profile store 205, the action log 220, and/or the edge store 225. For example, attributes associated with the viewing user may include information that describes the viewing user, such as demographic or biographic information, location information, hobbies or interests of the viewing user, etc. As an additional example, attributes associated with the viewing user may describe actions performed by the viewing user with objects maintained in the social networking system 140, such as information describing a connection established between the user and an additional user and clicks on various content items by the viewing user.

The social networking system 140 identifies 340 (e.g., using the group identification module 250) one or more groups of which the viewing user is not a member. The social networking system 140 may identify 340 one or more groups of which a viewing user is not a member based on stored information associated with the groups and the viewing user. For example, the social networking system 140 may retrieve information identifying one or more groups of which the viewing user is a member from the user profile store 205 (e.g., based on a group name or other identifier associated with each group stored in association with a profile of the viewing user), from the edge store 225 (e.g., based on information stored in association with an edge describing a connection between the user and each group), or from the group store 230 (e.g., based on a group mailing list associated with each group that includes information identifying the viewing user). In the above example, the social networking system 140 may then access the group store 230 and identify 340 one or more groups of which the viewing user is not a member (i.e., groups that were not identified in the retrieved information). As an additional example, the social networking system 140 accesses stored information (e.g., in the edge store 225) to determine whether a connection exists between each group and the viewing user; if no connection exists, the social networking system 140 determines that the viewing user is not a member of the group. In this example, if a connection exists, the social networking system 140 retrieves information stored in association with the connection and determines if the viewing user is a member of the group based on the retrieved information.

The social networking system 140 may identify 340 one or more groups of which a viewing user is not a member subject to privacy settings associated with the groups. For example, the social networking system 140 may identify 340 groups that allow anyone to join (“open” groups) or groups that require a user to request to join (“closed” groups) as groups of which a viewing user is not a member. As an additional example, the social networking system 140 may not identify 340 groups that require a user to be invited by an existing member in order to become a member (“secret” groups) as groups of which a viewing user is not a member.

In various embodiments, the social networking system 140 may identify 340 groups of which the viewing user is not a member based on the viewing user's membership statuses with respect to the groups. For example, when identifying 340 groups of which the viewing user is not a member, groups identified 340 by the social networking system 140 may include groups of which the viewing user was never a member, as well as groups of which the viewing user is a former member, but is not a current member. As an additional example, the social networking system 140 may not identify 340 a group as being among the groups of which the viewing user is not a member if the viewing user's membership in the group is pending (e.g., the viewing user has requested to join the group, but the request has been neither approved nor denied).

The social networking system 140 identifies 345 a candidate set of groups to recommend to the viewing user, in which each of the candidate set of groups is associated with membership criteria satisfied by the one or more attributes associated with the viewing user. In various embodiments, the social networking system 140 may identify 345 a candidate set of groups to recommend to the viewing user based on the information describing the one or more users who have attributes that satisfy the membership criteria associated with each group stored in step 330 above. For example, the social networking system 140 may access the user profile store 205 or the group store 230 and retrieve information identifying the candidate set of groups associated with membership criteria satisfied by one or more attributes associated with the viewing user.

In some embodiments, the social networking system 140 may retrieve 350 one or more topics associated with each of the candidate set of groups. The social networking system 140 may retrieve 350 a topic associated with a candidate group from the group store 230. For example, the social networking system 140 may access the group store 230 to retrieve 350 information stored in association with information identifying a group that describes one or more topics associated with the group that previously were inferred 315 by the social networking system 140.

The social networking system 140 computes 355 (e.g., using the scoring module 255) an affinity score associated with each of the candidate set of groups. The affinity score associated with each candidate group indicates an affinity of the viewing user for the candidate group. The social networking system 140 may compute 355 the affinity score associated with a candidate group based at least in part on a measure of similarity between the one or more attributes associated with the viewing user and a topic associated with the candidate group. For example, the social networking system 140 computes 355 an affinity score associated with a candidate group associated with the topic of oil painting based on a measure of similarity between attributes associated with a viewing user (e.g., retrieved from the user profile store 205, the edge store 225, and/or the action log 220) and the topic of oil painting. In this example, the social networking system 140 predicts that the viewing user has a high affinity for oil painting if profile information indicates that the viewing user majored in art or art history or that the viewing user's hobbies include oil painting and collecting oil paintings and if the viewing user has frequently clicked on and commented on content items associated with oil paintings. Accordingly, in this example, the social networking system 140 computes 355 a high affinity score associated with the candidate group that is proportional to the predicted affinity of the viewing user for the candidate group. Alternatively, in the above example, the social networking system 140 predicts that the viewing user has a low affinity for oil painting if profile information indicates that the viewing user majored in biology, that the viewing user's hobbies do not include painting or collecting oil paintings, and if the viewing user has never interacted with objects maintained in the social networking system 140 associated with oil painting. Therefore, in this example, the social networking system 140 computes 355 a low affinity score associated with the candidate group that is proportional to the predicted affinity of the viewing user for the candidate group.

The social networking system 140 may determine similarities between attributes associated with a viewing user and information maintained in the social networking system 140 that is associated with a candidate group by comparing metric spaces (e.g., using embeddings) or any other suitable method. For example, the social networking system 140 may use a metric space approach to determine a measure of similarity between an attribute associated with a viewing user and a topic associated with a candidate group (e.g., using a pairwise distance measure). In the above example, the social networking system 140 then computes 355 an affinity score associated with the content item that is proportional to the measure of similarity.

In some embodiments, the social networking system 140 may compute 355 the affinity score associated with a candidate group based on a distance between a geographic location associated with the viewing user and a portion of a geographical grid associated with the candidate group. For example, the affinity of the viewing user for a candidate group predicted by the social networking system 140 is inversely proportional to the distance between a geographic location associated with the viewing user and a portion of the geographical grid associated with the candidate group. In this example, the social networking system 140 computes 355 an affinity score associated with the candidate group that is proportional to the predicted affinity of the viewing user for the candidate group.

In various embodiments, an affinity score associated with a candidate group also may be computed 355 by the social networking system 140 based on other types of information associated with the viewing user and the candidate group that may indicate an affinity of the viewing user for the candidate group. For example, the social networking system 140 may compute 355 an affinity score associated with a candidate group based on a number of members of the group who are connected to the viewing user (e.g., friends or family members of the viewing user). In this example, the affinity score computed 355 for the candidate group may be proportional to the number of group members who are connected to the viewing user. As an additional example, the social networking system 140 may compute 355 an affinity score associated with a candidate group based on a measure of similarity between members of the candidate group and the viewing user. The measure of similarity between the members of the candidate group and the viewing user may be based on a number of users to whom members of the candidate group and the viewing user are mutually connected, based on similar demographic information associated with members of the candidate group and the viewing user, or any other suitable measure of similarity. The social networking system 140 may then compute 355 the affinity score associated with the candidate group such that the affinity score is proportional to the measure of similarity between the members of the candidate group and the viewing user.

The social networking system 140 ranks 360 (e.g., using the group selection module 260) the candidate set of groups based at least in part on the affinity score associated with each of the candidate set of groups. For example, the social networking system 140 ranks 360 multiple candidate groups based on their affinity scores, such that the highest ranked group is associated with the highest affinity score, the second highest ranked group is associated with the second highest affinity score, etc. In some embodiments, the social networking system 140 also may rank 360 the candidate set of groups based on the viewing user's membership status with respect to each group. For example, even if the viewing user satisfies membership criteria associated with a candidate group and is not a member of the candidate group, the social networking system 140 may not rank 360 the candidate group if the viewing user is a former member of the group.

The social networking system 140 selects 365 (e.g., via the group selection module 260) one or more groups from the candidate set of groups to recommend to the viewing user based at least in part on the ranking. In one embodiment, the social networking system 140 selects 365 the group(s) for recommendation to the viewing user based on a position of the group(s) within the ranking. For example, the social networking system 140 selects 365 the highest ranked group for recommendation to the viewing user. In another embodiment, the social networking system 140 selects 365 the group(s) for recommendation to the viewing user based on the affinity scores associated with each of the candidate groups. For example, if the two highest ranked groups are associated with at least a threshold affinity score, both of these groups are selected 365 for recommendation to the viewing user. In some embodiments, the social networking system 140 may select 365 one or more groups to recommend to the viewing user based on the viewing user's membership status with respect to the groups. For example, even if a candidate group is associated with at least a threshold affinity score, the social networking system 140 may not select 365 the candidate group for recommendation to the viewing user if the viewing user's membership in the group is pending.

In various embodiments, the social networking system 140 generates 370 (e.g., using the interface module 265) a user interface that includes a recommendation that the viewing user join the selected 365 group(s). For example, as shown in FIG. 5, the social networking system 140 generates 370 a recommendation unit 505 that indicates that the viewing user will likely have an interest in one or more groups 510A-E described by information included in the recommendation unit 505. In this example, the recommendation unit 505 may include a window viewing area 515 and a scroll bar 520 that allows the viewing user to move the information describing each group 510A-E being recommended into the window viewing area 515. In some embodiments, the selected 365 groups 510A-E included in the recommendation unit 505 may be ordered based on the affinity scores 525 associated with each selected 365 group. For example, information describing the group 510A associated with the highest affinity score 525 may be included in a most prominent position of the recommendation unit 505, while information describing the group 510B associated with the second highest affinity score 525 may be included in a second most prominent position of the recommendation unit 505, etc.

Information included in the user interface describing a group being recommended to the viewing user may include a title of the group, a cover photo for the group, a short description of the group, topics associated with the group, etc. In some embodiments, the user interface also may include contextual information describing why the group is being recommended to the viewing user. For example, a recommendation unit may explain that a group is being recommended to the viewing user based on a geographic location associated with the group that is close to a geographic location associated with the viewing user, based on similarities between the group and another group of which the viewing user is a member, based on similarities between content currently being viewed by the viewing user and content posted by members of the group, and based on information describing members of the group (e.g., information identifying friends of the viewing user who are members of the group, etc.).

The user interface generated 370 by the social networking system 140 may allow the viewing user to submit a request to join a group described in the user interface or to request to view additional information associated with a group described in the user interface. For example, a recommendation unit may include information describing multiple groups selected 365 by the social networking system 140 (e.g., a name, group photo, and a description of each group), in which information describing each group is presented in conjunction with a “join” button that allows the viewing user to submit a request to join the group by clicking on the button and a “learn more” button that presents the viewing user with a page for the group maintained in the social networking system 140 upon clicking on the button.

Referring once more to FIG. 3, the social networking system 140 sends 375 the recommendation to join the selected 365 group for display to the viewing user. The social networking system 140 may send 375 the recommendation that the viewing user join the selected 365 group(s) for display to the viewing user via a client device 110 associated with the viewing user. For example, the social networking system 140 may communicate the recommendation unit including the recommendation to a mobile device associated with the viewing user when the viewing user uses the mobile device to access the social networking system 140. In the above example, the recommendation unit may be presented to the viewing user in a display area of the mobile device in conjunction with content items included in a feed of content items (e.g., in a newsfeed) or independently (e.g., along the right-hand side of the display area of the mobile device).

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining information in a social networking system describing a plurality of groups, each group having membership criteria including attributes for members of the group and each group having content posted to the social networking system by one or more members of the group, each of the members of the group being a user of the social networking system;
inferring one or more topics associated with each of the plurality of groups based at least in part on the content posted to the social networking system by a member of the group and the attributes for members of the group;
identifying one or more users of the social networking system having attributes that satisfy the membership criteria of each of the plurality of groups;
identifying an opportunity to recommend, to a viewing user of the one or more users, that the viewing user join one or more of the plurality of groups, the viewing user associated with one or more attributes;
identifying the one or more of the plurality of groups of which the viewing user is not a member;
identifying a candidate set of groups from the one or more of the plurality of groups, wherein the one or more attributes associated with the viewing user satisfy the membership criteria associated with each of the candidate set of groups;
computing an affinity score associated with each of the candidate set of groups, the affinity score indicating an affinity of the viewing user for each of the candidate set of groups and computed based at least in part on a measure of similarity between the one or more attributes associated with the viewing user and a topic associated with each of the candidate set of groups;
ranking the candidate set of groups based at least in part on the affinity score associated with each of the candidate set of groups;
selecting a group from the candidate set of groups based at least in part on the ranking; and
sending a recommendation for display to the viewing user to join the selected group.

2. The method of claim 1, wherein the information maintained in the social networking system describing the plurality of groups comprises a geographic location associated with each of the plurality of groups.

3. The method of claim 2, further comprising:
partitioning the plurality of groups into a geographical grid based at least in part on the geographic location associated with each of the plurality of groups.

4. The method of claim 3, further comprising:
retrieving information describing one or more geographic locations associated with the viewing user.

5. The method of claim 4, wherein computing the affinity score associated with each of the candidate set of groups is further based at least in part on a distance between the one or more geographic locations associated with the viewing user and one or more portions of the geographical grid into which the plurality of groups is partitioned.

6. The method of claim 4, wherein the one or more geographic locations associated with the viewing user comprise one or more selected from a group consisting of: a residence of the viewing user, a workplace of the viewing user, an educational establishment attended by the viewing user, and any combination thereof.

7. The method of claim 1, wherein the membership criteria of each group comprise one or more selected from a group consisting of: demographic information associated with each member of the group, information describing a geographic location associated with each member of the group, an answer received from each member of the group to a question received from an administrator of the group, and any combination thereof.

8. The method of claim 1, wherein the content posted to the social networking system by one or more members of the group comprises metadata describing the one or more topics associated with each of the plurality of groups.

9. The method of claim 1, wherein the one or more topics associated with each of the plurality of groups comprises a sentiment shared by members of a group of the plurality of groups.

10. The method of claim 1, wherein the one or more topics associated with each of the plurality of groups are inferred using a machine-learning algorithm.

11. The method of claim 1, wherein the affinity score associated with each of the candidate set of groups is proportional to the measure of similarity between the one or more attributes associated with the viewing user and the topic associated with each of the candidate set of groups.

12. A computer program product comprising a computer readable storage medium having instructions encoded thereon that, when executed by a processor, cause the processor to:
maintain information in a social networking system describing a plurality of groups, each group having membership criteria including attributes for members of the group and each group having content posted to the social networking system by one or more members of the group, each of the members of the group being a user of the social networking system;
infer one or more topics associated with each of the plurality of groups based at least in part on the content posted to the social networking system by a member of the group and the attributes for members of the group;
identify one or more users of the social networking system having attributes that satisfy the membership criteria of each of the plurality of groups;
identify an opportunity to recommend, to a viewing user of the one or more users, that the viewing user join one or more of the plurality of groups, the viewing user associated with one or more attributes;
identify the one or more of the plurality of groups of which the viewing user is not a member;
identify a candidate set of groups from the one or more of the plurality of groups, wherein the one or more attributes associated with the viewing user satisfy the membership criteria associated with each of the candidate set of groups;
compute an affinity score associated with each of the candidate set of groups, the affinity score indicating an affinity of the viewing user for each of the candidate set of groups and computed based at least in part on a measure of similarity between the one or more attributes associated with the viewing user and a topic associated with each of the candidate set of groups;
rank the candidate set of groups based at least in part on the affinity score associated with each of the candidate set of groups;
select a group from the candidate set of groups based at least in part on the ranking; and
send a recommendation for display to the viewing user to join the selected group.

13. The computer program product of claim 12, wherein the information maintained in the social networking system describing the plurality of groups comprises a geographic location associated with each of the plurality of groups.

14. The computer program product of claim 13, wherein the computer readable storage medium further has instructions encoded thereon that, when executed by the processor, cause the processor to:
partition the plurality of groups into a geographical grid based at least in part on the geographic location associated with each of the plurality of groups.

15. The computer program product of claim 14, wherein the computer readable storage medium further has instructions encoded thereon that, when executed by the processor, cause the processor to:
retrieve information describing one or more geographic locations associated with the viewing user.

16. The computer program product of claim 15, wherein compute the affinity score associated with each of the candidate set of groups is further based at least in part on a distance between the one or more geographic locations associated with the viewing user and one or more portions of the geographical grid into which the plurality of groups is partitioned.

17. The computer program product of claim 15, wherein the one or more geographic locations associated with the viewing user comprise one or more selected from a group consisting of: a residence of the viewing user, a workplace of the viewing user, an educational establishment attended by the viewing user, and any combination thereof.

18. The computer program product of claim 12, wherein the membership criteria of each group comprise one or more selected from a group consisting of: demographic information associated with each member of the group, information describing a geographic location associated with each member of the group, an answer received from each member of the group to a question received from an administrator of the group, and any combination thereof.

19. The computer program product of claim 12, wherein the content posted to the social networking system by one or more members of the group comprises metadata describing the one or more topics associated with each of the plurality of groups.

20. The computer program product of claim 12, wherein the one or more topics associated with each of the plurality of groups comprises a sentiment shared by members of a group of the plurality of groups.

21. The computer program product of claim 12, wherein the one or more topics associated with each of the plurality of groups are inferred using a machine-learning algorithm.

22. The computer program product of claim 12, wherein the affinity score associated with each of the candidate set of groups is proportional to the measure of similarity between the one or more attributes associated with the viewing user and the topic associated with each of the candidate set of groups.

23. A method comprising:
maintaining information in a social networking system describing a plurality of groups, each group having content posted to the social networking system by one or more members of the group, each member of the group being a user of the social networking system;
inferring one or more topics associated with each of the plurality of groups based at least in part on the content posted to the social networking system by a member of the group;
identifying an opportunity to recommend, to a viewing user of the social networking system, that the viewing user join one or more of the plurality of groups, the viewing user associated with one or more attributes;
identifying a candidate set of groups from the plurality of groups, wherein the viewing user is not a member of any of the candidate set of groups;
computing an affinity score associated with each of the candidate set of groups, the affinity score indicating an affinity of the viewing user for each of the candidate set of groups and computed based at least in part on a measure of similarity between the one or more attributes associated with the viewing user a topic associated with each of the candidate set of groups; and
selecting a group from the candidate set of groups based at least in part on the affinity score associated with each of the candidate set of groups.

24. The method of claim 23, further comprising:
generating a recommendation for the viewing user to join the group selected from the candidate set of groups.

25. The method of claim 24, further comprising:
sending the recommendation for display to the viewing user.
